(19) United States
(12) Patent Application Publication
(10) Pub. No.: US 2019/0126418 A1
(43) Pub. Date: May 2, 2019

(54) Battery Powered Right Angle Aircraft Drill

(71) Applicant: Bachus and Son, Inc., Wichita, KS (US)

(72) Inventor: Ryan J. Bendell, Wichita, KS (US)

(21) Appl. No.: 16/144,415

(22) Filed: Sep. 27, 2018

Related U.S. Application Data
(60) Provisional application No. 62/567,116, filed on Oct. 2, 2017.

(51) Int. Cl. B23Q 5/04; B25F 5/00

(52) U.S. Cl. CPC B23Q 5/045; B25F 5/001

(57) ABSTRACT

The present invention relates to a battery powered right angle aircraft drill comprising a motor, an adapter collar, a spindle gear shaft, and an angled head. An electrically powered motor rotates a shaft. The adapter collar secures the motor to the angled head, establishing a formlocking connection between the motor and the angled head along an axis, the adapter being annular and having an opening extending therethrough. The shaft of the motor is cooperatively joined to the spindle gear shaft. The spindle gear shaft has a first end extending to a second end, the first end joined to the shaft of the motor, the second end of the spindle gear shaft includes splines. The angled head includes splines mating to the splines of the spindle gear shaft, and further includes a tool bit receptacle, whereby the rotational force of shaft of the motor is translated through the spindle gear shaft to the angled head, actuating a tool bit in the tool bit receptacle.

### BACKGROUND

### Field of the Invention

The present invention relates to aircraft drills, more specifically to battery powered aircraft drills.

### Description of the Related Art

The aircraft industry has commonly utilized a pneumatic right angle drill for years. An air hose has to be attached to a pneumatic right angle drill for operation, which decreases the effective range of use of the drill and requires extra equipment to utilize the drill.

### SUMMARY

The present invention relates to a battery powered right angle aircraft drill comprising a motor, an adapter collar, a spindle gear shaft, and an angled head. The motor comprises an electrically powered motor providing rotational force to a shaft at suitable rotation speeds for working with airplane materials. The adapter collar secures the motor to the angled head, establishing a formlocking connection between the motor and the angled head along an axis, the adapter being annular and having an opening extending therethrough. The shaft of the motor is cooperatively joined to the spindle gear shaft, thereby translating its force.

The spindle gear shaft has a first end extending to a second end, the first end joined to the shaft of the motor, the second end of the spindle gear shaft includes splines. The angled head includes splines mating to the splines of the spindle gear shaft, and further includes a tool bit receptacle, the tool bit receptacle angularly oriented from the axis, whereby the rotational force of shaft of the motor is translated through the spindle gear shaft to the angled head, actuating a tool bit in the tool bit receptacle.

These and other features, aspects, and advantages of the invention will become better understood with reference to the following description, and accompanying drawings.

### BRIEF DESCRIPTION OF THE DRAWINGS

FIG. 1 depicts a side view of an embodiment of a battery powered right angle aircraft drill according to the current invention;

FIG. 2 depicts a partial cutaway view of an embodiment of a battery powered right angle aircraft drill according to the current invention;

FIG. 3 depicts an exploded view of an embodiment of a battery powered right angle aircraft drill according to the current invention;

FIGS. 4A and 4B depict a configuration of an adapter collar;

FIGS. 5A and 5B depict a configuration of a spindle gear shaft;

FIG. 6 depicts a cutaway view of a configuration of a right angle head; and

FIG. 7 depicts a side view of a tool bit oriented for attachment to a right angle head.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

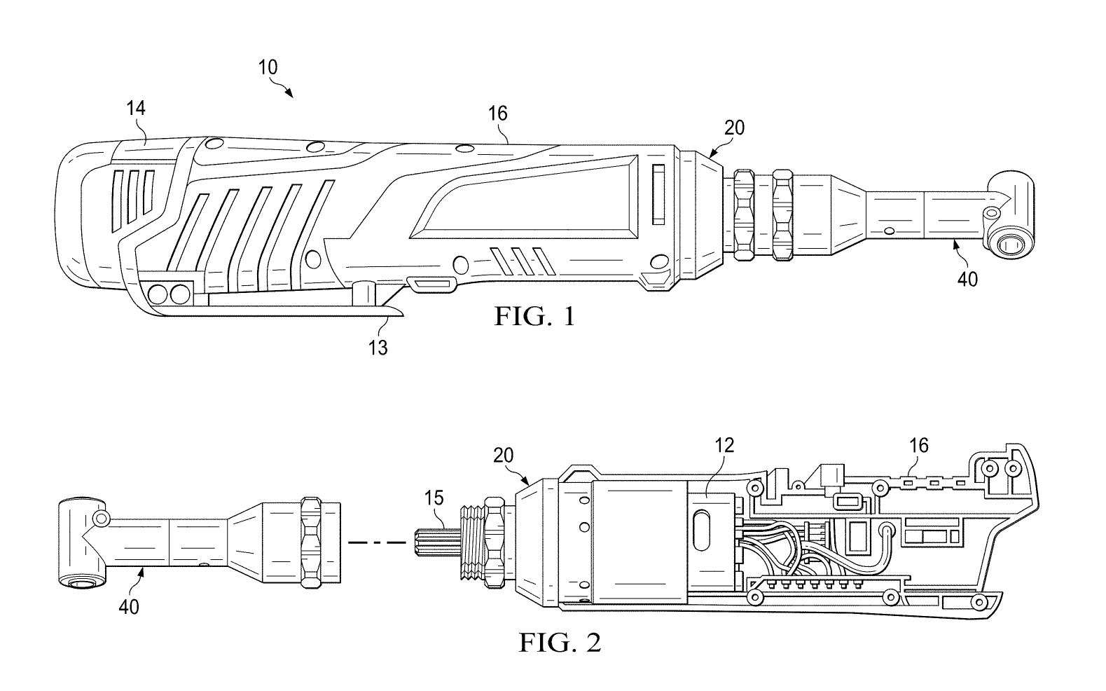

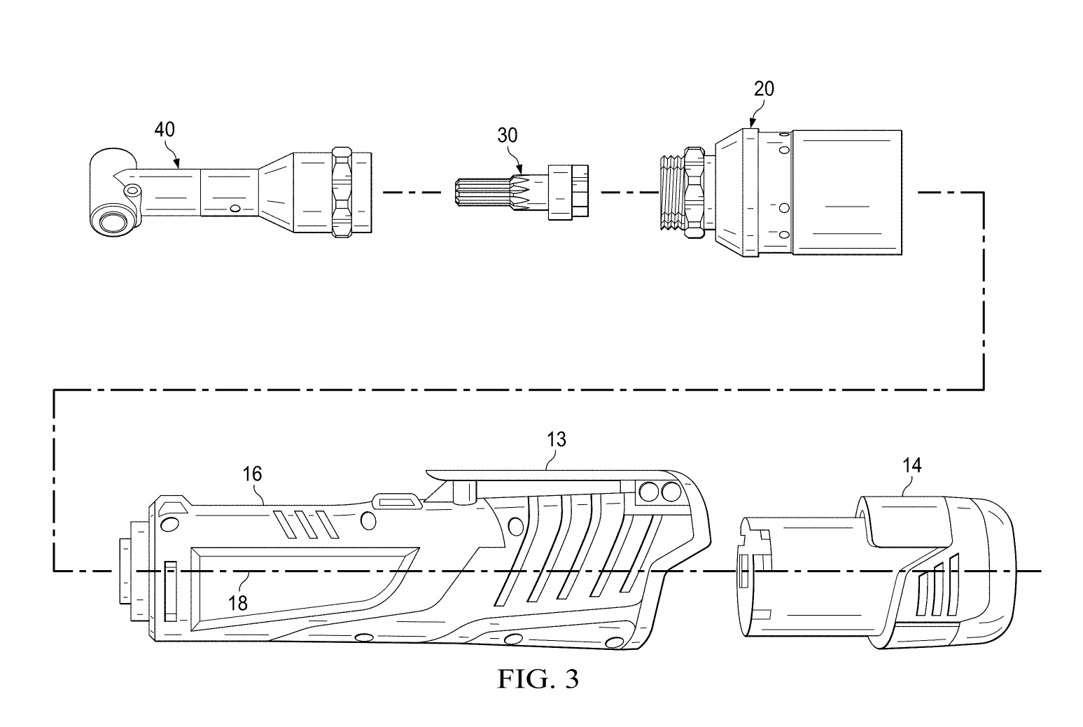

The present invention is directed to a battery powered right angle aircraft drill. FIG. 1 illustrates a housed embodiment of a battery powered right angle aircraft drill 10. FIG. 2 illustrates a partial cutaway of an embodiment of a battery powered right angle aircraft drill 10, while FIG. 3 illustrates a semi-exploded view of an embodiment of a battery powered right angle aircraft drill 10. Depicted are a battery powered motor 12, an adapter collar 20, a spindle gear shaft 30, and a right angle head 40 joined in a formlocking connection along an axis 18. As illustrated, the motor 12 is mounted inside the housing 16.

The battery powered right angle aircraft drill 10 includes an electrically powered motor 12 for providing rotational force. An exemplary electrically powered member 12 is an electric motor, such as the illustrated battery powered motor 12. The battery powered motor 12 is an electrical machine that converts electrical energy into mechanical energy. In the current embodiment, a battery 14 is the power source and the mechanical energy output is delivered via a shaft 15. A switch 13 allows a user to power the motor 12, which activates the motor 12 and rotates the shaft 15. In certain configurations, a variable speed trigger 13, allows a user to vary the output of the motor 12, which powers the motor 12 and rotates the shaft 15. The throttle handle 13, varies the output power, in turn varying the RPM, with an optional stop plate on the throttle handle 13 limiting the RPM range.

Suitable rotation speeds are those which rotate the tool bit 50 in range for working with airplane materials, such as aluminum on airplanes. In certain configurations, a suitable target rotations per minute (RPM) range to the head would rotate between 2500 RPM-4000 RPM.

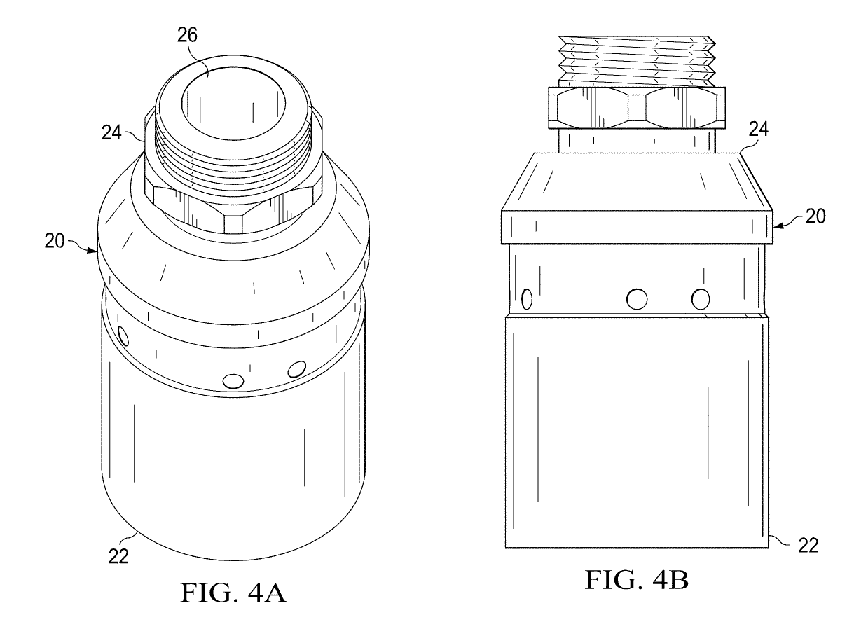

An example adapter collar 20 is illustrated in FIGS. 4A and 4B. The adapter collar 20 is shaped as a to secure the motor 12 to the right angle head 40, for establishing the axial formlocking connection between them. The adapter collar 20 has a first end 22, second end 24, and an opening 26 extending therethrough. In certain configurations, it further includes a depth stop. In certain configurations, the depth stop is formed as a ring-shaped body displaceable over the push-on sleeve and having an annular portion engageable for securing to the end of the motor 12 section. A depth stop may include the first end 22 being fitted around the motor body or motor body housing 16. The shaft 15 of the motor 12 extends through the opening 26 of the adapter collar 20 at its first end 22.

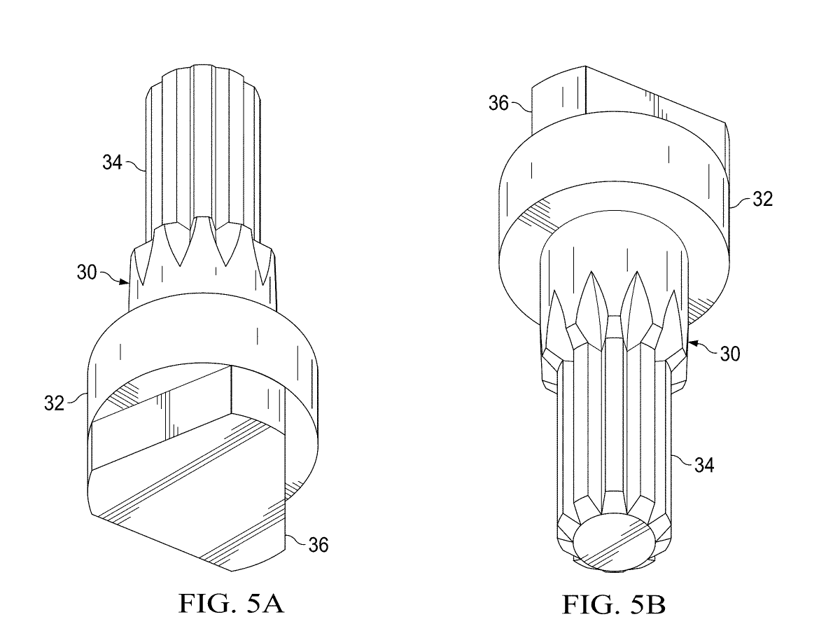

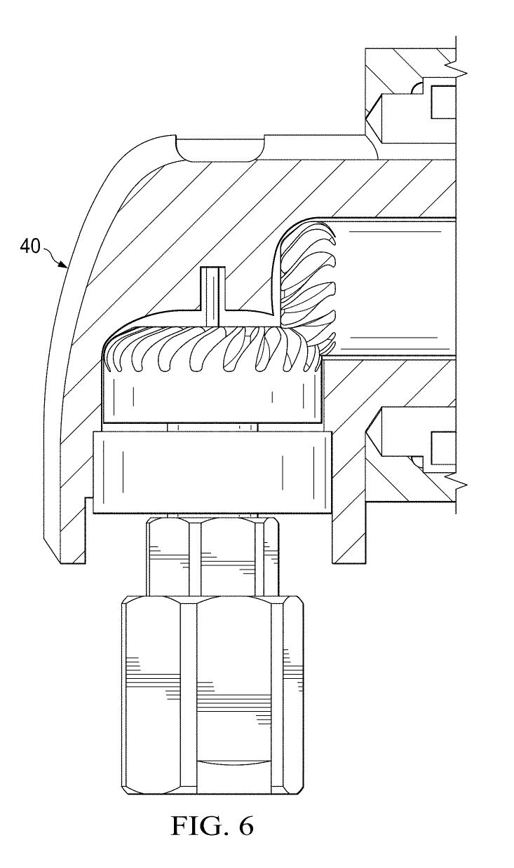

An exemplary spindle gear shaft 30 has a first end 32 and second end 34. In certain embodiments, a head 36 extends from the first end 32. In certain configurations, the head has a shaped cross-section, being generally triangular in the figure. The spindle gear shaft 30 extends to the second end 34. In the illustrated embodiment, the shaft 15 of the motor 12 extends through the opening 26 to the second end 34 of the adapter collar 20. An example spindle gear shaft 30, operable to further translate the mechanical force from the shaft 15, is illustrated in FIGS. 5A and 5B. One end is operable to adapt to the battery motor and the other end to the splines in the angled head 40. The spindle gear shaft 30 has a first end 32, second end 34. The first end 32 of the spindle gear shaft 30 has a receiving cross-section 36 for mating to the cross-section of the shaft 15, whereby the shaft 15 can be cooperatively joined to the spindle gear shaft 30, thereby translating its force. This enables a direct transmission of torque from the shaft 15 through the spindle gear shaft 30. The second end 34 of the spindle gear shaft 30 includes splines 38, operable to mesh with the corresponding splines 38 and further translate the mechanical action of the shaft 15 to the angled head 40. The combination of the number of spline, length of the spindle gear shaft 30, tolerance, weight, and heat dissipation are configured for target RPM, minimal gear noise, and minimal play.

An exemplary angled head 40, operable to further translate the mechanical action from the shaft 15, is illustrated in FIGS. 3 and 6. The output mechanical action is angled from the primary axis 18 of the tool 10, about at a right angle in exemplary configuration. In other configurations, it is angled from about 75° to 105°. The right angle head 40 is powered by the spindle gear shaft 30. The right angle head 40 has a first end 42, second end 44, with a tool bit receptacle 46 for receipt of a tool bit 50 disposed proximate the second end 44. In exemplary configuration, the tool bit receptacle 46 includes female threading for secure receipt of correspondingly male threaded bits 50.

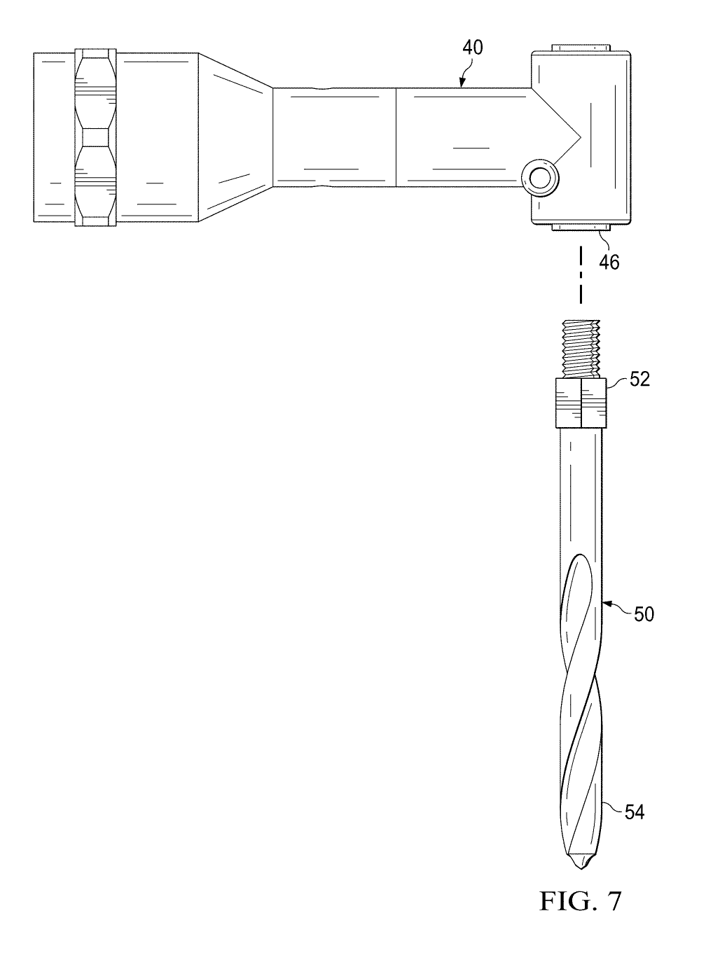

A suitable tool bit 50 is illustrated in FIG. 7. The operable to further translate the mechanical action from the shaft 15, The exemplary tool bit 50 has a threaded section at its first end 52 and its tooling structure at its second end 54. A representative suitable tool bit 50 is a ¼″-28 threaded aircraft drill bit, generally illustrated in FIG. 7.

In exemplary embodiments, the battery powered motor 12, adapter collar 20, spindle gear shaft 30, and right angle head 40 are joined together in a formlocking connection along the axis 18. The battery powered motor 12 may be enclosed or partially enclosed in housing 16. The shaft 15 of the motor 12 extends from the housing 16 and is enclosed within the adapter collar 20. The shaft 15 is cooperatively, securely attached to the first end 32 of the spindle gear shaft 30. The second, splined end 32 of the spindle gear shaft 30 is further cooperatively, secured to the right angle head 40, with the tool 10 being ready for a user at that point, at which a tool bit is mountable. A user engages a threaded tool bit 50 to the counter-threaded tool bit receptacle 46 of the right angle head 40. The user then engages the threaded aircraft drill bit 50 to the work surface, pressing it against a workpiece, and depresses the switch 13 of the electric motor 12 to power the drill and pushed the right angle head 40 against the work surface.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. An aircraft drill comprising:
a motor, an adapter collar, a spindle gear shaft, and an angled head;
said motor comprising an electrically powered motor providing rotational force to a shaft at suitable rotation speeds for working with airplane materials;
said adapter collar securing said motor to the angled head, establishing a formlocking connection between said motor and said angled head along an axis, said adapter being annular, having an opening extending therethrough;
said shaft of the motor extending through said opening of the said adapter collar at its first end, said shaft cooperatively joined to said spindle gear shaft, thereby translating its force;
said spindle gear shaft having a first end extending to a second end, said first end joined to said shaft of said motor, said second end of said spindle gear shaft including splines;
said angled head having splines mating to said splines of said spindle gear shaft, further having a tool bit receptacle, said tool bit receptacle angularly oriented from said axis;
whereby said rotational force of shaft of said motor is translated through said spindle gear shaft to said angled head, actuating a tool bit in said tool bit receptacle.

2. The aircraft drill of claim 1, further comprising a battery.

3. The aircraft drill of claim 1, further comprising a switch, operable to power said motor.

4. The aircraft drill of claim 1, further comprising a variable speed trigger, operable to enable a user to vary the output of the motor.

4. The aircraft drill of claim 1, wherein said airplane material is aluminum.

5. The aircraft drill of claim 1, wherein said target rotations per minute range is between about 2500 to about 4000.

6. The aircraft drill of claim 1, further comprising further comprising housing, wherein said motor disposed inside said housing.

7. The aircraft drill of claim 1, wherein said spindle gear shaft further comprises a head at its first end, said head having a shaped cross-section.

8. The aircraft drill of claim 7, wherein shaped cross-section comprises a generally triangular shape.

9. The aircraft drill of claim 1, wherein said adapter collar further comprises a depth stop.

10. The aircraft drill of claim 9, wherein said depth stop is formed as an annular body, for slidable engagement to the end of the motor section.

11. The aircraft drill of claim 1, wherein said tool bit receptacle is angularly oriented from said axis at about a right angle.

12. The aircraft drill of claim 1, wherein said tool bit receptacle is angularly oriented from said axis from about 75° to 105°.

13. The aircraft drill of claim 1, where said tool bit receptacle includes threading for secure receipt of correspondingly inversely threaded tool bits.

14. The aircraft drill of claim 13, further comprising a tool bit having a threaded section at its first end and its tooling structure disposed at its second end.

15. The aircraft drill of claim 14, wherein said tool bit comprises a ¼″-28 threaded aircraft drill bit.

16. An aircraft drill comprising:
a motor, an adapter collar, a spindle gear shaft, and an angled head;
said motor comprising a battery powered motor providing rotational force to a shaft at suitable rotation speeds for working with airplane materials;
said adapter collar securing said motor to the angled head, establishing a formlocking connection between said motor and said angled head along an axis, said adapter being annular, having an opening extending therethrough;
said shaft of the motor extending through said opening of the said adapter collar at its first end, said shaft cooperatively joined to said spindle gear shaft, thereby translating its force;
said spindle gear shaft having a first end extending to a second end, said first end joined to said shaft of said motor, said second end of said spindle gear shaft including splines;
said angled head having splines mating to said splines of said spindle gear shaft, further having a tool bit receptacle, said tool bit receptacle angularly oriented from said axis at about a right angle;
whereby said rotational force of shaft of said motor is translated through said spindle gear shaft to said angled head, actuating a tool bit in said tool bit receptacle.

17. The aircraft drill of claim 17, wherein said airplane material is aluminum.

18. The aircraft drill of claim 17, where said tool bit receptacle includes threading for secure receipt of correspondingly inversely threaded tool bits.

19. The aircraft drill of claim 18, further comprising a tool bit having a threaded section at its first end and its tooling structure disposed at its second end.

20. The aircraft drill of claim 19, wherein said tool bit comprises a ¼″-28 threaded aircraft drill bit.
